(19) United States
(12) Patent Application Publication
(10) Pub. No.: US 2014/0063835 A1
(43) Pub. Date: Mar. 6, 2014

(54) BULB FIXING INTO SLEEVE FOR A VEHICLE HEADLAMP

(71) Applicant: György Péter Szabó, Budapest (HU)

(72) Inventor: György Péter Szabó, Budapest (HU)

(21) Appl. No.: 13/605,606

(22) Filed: Sep. 6, 2012

(51) Int. Cl. B60Q 1/04

(52) U.S. Cl. 362/548

(57) ABSTRACT

A headlamp for an automobile is provided with one or more features that improve the positioning of the headlamp during installation and the securing of the headlamp during use. More particularly, the bulb is provided with one or more raised features that are matched by complementary features on a sleeve into which the bulb is inserted. Such features can be provided along one side or opposing sides of the bulb.

### FIELD OF THE INVENTION

The subject matter of the present disclosure relates generally to the fixing or securing of a burner into a sleeve for a bulb that may be used in a vehicle headlamp.

### BACKGROUND OF THE INVENTION

Bulbs for use in automobile headlamps (i.e. the lamps on the front of the vehicle sometimes referred to as “headlights”) are subject to stringent regulatory parameters that can vary depending upon the nation where the bulbs will be used. In addition to requirements for the amount of light generated by the headlamp, such regulations typically specify certain dimensions and tolerances for such dimensions as well. For example, the H1 and H3 are types of commonly used bulbs that are subject to extensive regulations. Accordingly, manufacturers must take steps to both design and manufacture bulbs within these requirements.

During use in the automobile, the headlamp may operate in various modes such as e.g., a dim mode and a bright mode as the vehicle travels along the motorway. While in use, it is important that the bulbs remain correctly oriented so that the light is projected in the proper direction. For example, preferably the lights remain directed onto the roadway ahead rather than directly into oncoming traffic.

Unfortunately, during installation and/or use, bulbs used in the headlamps may become improperly positioned. During a repair or replacement, the consumer may improperly position the bulb. Additionally, the bulb may become slightly displaced due to vibrations during use of the automobile. Depending upon the extent to which the bulb or burner is improperly positioned, the automobile's path may not be properly illuminated and/or the headlamps may even point undesirably into oncoming traffic.

In an effort to prevent such misalignment, regulations typically limit the amount of movement or displacement of the bulb for a given amount of force applied thereto. For example, the regulations may specify the amount of burner movement allowed for a given amount of force applied along a certain direction to an installed bulb.

Accordingly, a bulb for an automobile headlamp having one or more features that can be used to properly and positively secure the bulb during installation and use in an automobile would be beneficial. An H1 or H3 style headlamp that can be provided with such features would also be particularly useful.

### BRIEF DESCRIPTION OF THE INVENTION

The present invention provides a bulb for an automobile headlamp with one or more features that improve the ability of the bulb to resist improper alignment that can result during installation and use. More particularly, the burner is provided with one or more raised features that are matched by complementary features on a sleeve into which the burner is inserted. These features provide for a more rigid fit between the burner and the sleeve. Such features can be provided e.g., along one side or a pair of opposing sides of the bulb. Additional advantages of the invention will be set forth in part in the following description, or may be apparent from the description, or may be learned through practice of the invention.

In one exemplary embodiment, the present invention provides a bulb for a vehicle headlamp. The bulb includes a burner defining a longitudinal axis and having a base portion connected to a chamber portion. The base portion includes a pair of opposing wide sides and a pair of opposing narrow sides. At least one rib is positioned on one of the wide sides of the base portion and extends along the longitudinal direction. At least one elongated, raised strip is positioned on one of the wide sides of the base portion and extends at an angle θ to the longitudinal direction with the angle θ being greater than zero. A light emitting element extends into the chamber portion. A sleeve can be provided with e.g., complementary features for receipt of the burner.

In another exemplary embodiment, the present invention provides a bulb for a vehicle. The bulb includes a burner having a base portion connected to a chamber portion. The base portion includes a pair of opposing wide sides and a pair of opposing narrow sides. The burner further includes at least one rib centrally positioned on one of the wide sides of the base portion and extending along a longitudinal direction of the burner. At least one strip is positioned on one of the wide sides of the base portion and extends at an angle θ to the longitudinal direction.

A light emitting element is positioned in the chamber portion. A sleeve can be provided with e.g., complementary features for receipt of the burner.

In another exemplary embodiment, the present invention provides a sleeve for receipt of a burner for a vehicle headlamp. The burner defines a longitudinal axis and has a base portion and a chamber portion. The sleeve comprises a channel into which the base portion of the burner may be received. The sleeve also includes at least one orienting aperture. A pair of plates are positioned in an opposing manner about the longitudinal axis and extend into the channel of the sleeve. The pair of plates define at least part of the at least one orienting aperture. The pair of plates include a pair of first edges positioned in an opposing manner about the longitudinal axis, each of the first edges positioned at an angle α from the longitudinal axis and configured for positioning adjacent to a strip positioned on the base portion of the burner. The pair of plates also includes a pair of second edges positioned in an opposing manner about the longitudinal axis, each of the second edges positioned at an angle β from the longitudinal axis.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIGS. 1 and 2 provide perspective views of the opposing wide sides of an exemplary burner of the present invention.

FIG. 3 provides a front view of an exemplary sleeve of the present invention.

FIG. 4 provides a side view of the exemplary sleeve of FIG. 3.

FIG. 5 is a perspective view of another exemplary embodiment of the present invention.

FIG. 6 is a front view of the exemplary bulb of FIGS. 1 and 2 as received into the exemplary sleeve of FIG. 3.

FIG. 7 is a side view of the exemplary embodiment illustrated in FIG. 6.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

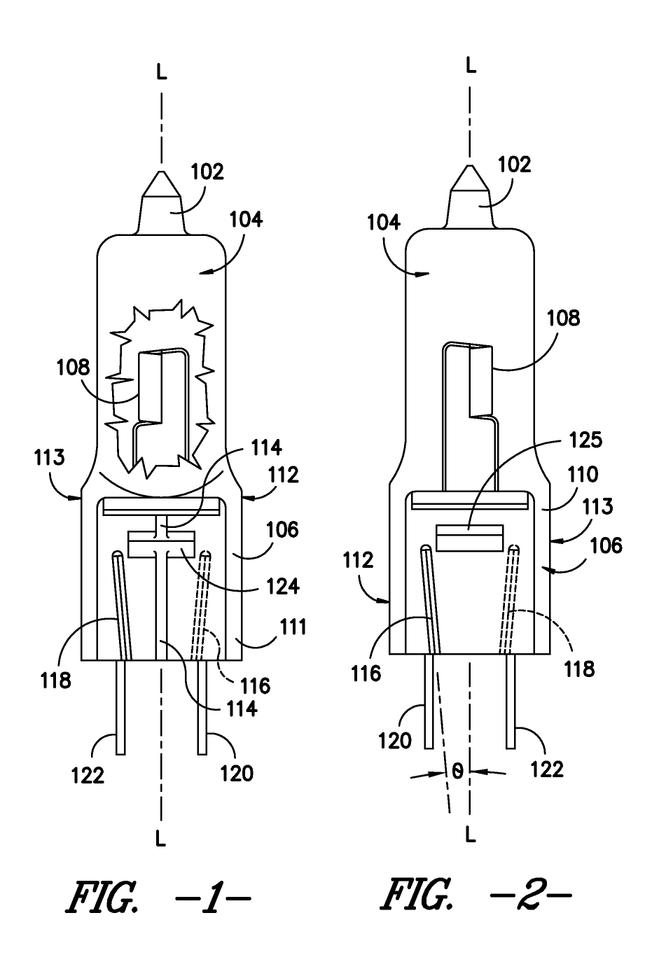

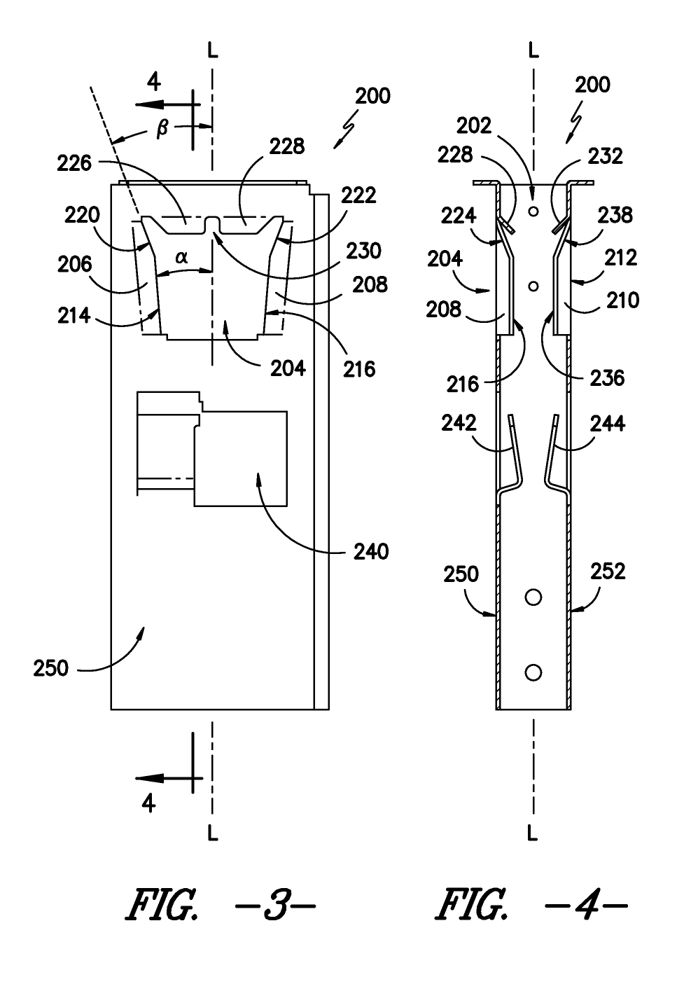

FIGS. 1 and 2 provide perspective views of an exemplary embodiment of a burner 102 of the present invention. Burner 102 has a pair of opposing sides, namely wide side 110 (shown in FIG. 1) and wide side 111 (shown in FIG. 2). A pair of opposing narrow sides 112 and 113 connect between wide sides 110 and 111. While burner 102 is shown configured as an H1 type, one of skill in the art will understand using the teachings disclosed herein that other types such as e.g., an H3 type may be used with the present invention as well.

Burner 102 defines a longitudinal axis L extending along the length of burner 102 as shown and includes a pinched or base portion 106 connected to a chamber portion 104. A light producing element or filament 108 extends into chamber portion 104 from base portion 106. Electrodes 120 and 122 are connected with filament 108 and extend from base portion 106 for connection with a power source. Burner 102 may be constructed from e.g., a glass material in the shape shown. Other shapes may be used e.g., with chamber portion 104 and/or base portion 106.

For this exemplary embodiment, base portion 106 includes a pair of elongated, raised strips 116 and 118 positioned on opposing wide sides 110 and 111. Strips 116 and 118 may be formed from e.g., glass features forming part of base portion 106 that are raised or elevated relative to base portion 106. As shown in FIG. 2, each strip 116 and 118 is at an angle θ from the longitudinal direction L. For example, angle θ may be in the range of about 2.5 degrees to 10 degrees. Other non-zero values may be used in other embodiments of the invention as well. As described below, strips 116 and 118 limit and fix the movement of burner 102 in a receiving sleeve.

As shown in FIGS. 1 and 2, for this exemplary embodiment burner 102 includes a single strip 116 or 118 positioned on opposing wide sides 110 and 111, respectively. However, other combinations of strips may be used as well. For example, burner 102 may be constructed with only one strip on one of the wide sides, two strips on the same wide side, two strips on one wide side and a single strip on the opposing wide side, or two strips on each of the wide sides.

Burner 102 also includes a rib 114 that is centrally positioned on wide side 110. Rib 114 extends along the longitudinal direction L. A knob or stop 124 extends orthogonally to longitudinal direction L and intersects rib 114 as shown. For this exemplary embodiment, rib 114 is constructed of two portions—each located on different sides of stop 124 along the longitudinal direction L.

By way of example, rib 114 and stop 124 may be formed from e.g., glass features forming part of base portion 106 that are raised or elevated relative to base portion 106. As will be described below, rib 114 helps guide the insertion of bulb 102 into a receiving sleeve while stop 124 helps fix or hold the position of bulb 102 into the sleeve once inserted.

For the exemplary embodiment shown in FIGS. 1 and 2, a single rib 114 is positioned on wide side 110. However, other configurations may be used as well. For example, a rib may be positioned in a similar manner only on wide side 111 or on both sides 110 and 111. A stop 124 may also be positioned on side 111 in a manner similar to that shown for side 110. Other configurations may also be used. Additionally, various combinations of ribs, stops, and strips may be created using e.g., the above-described variations.

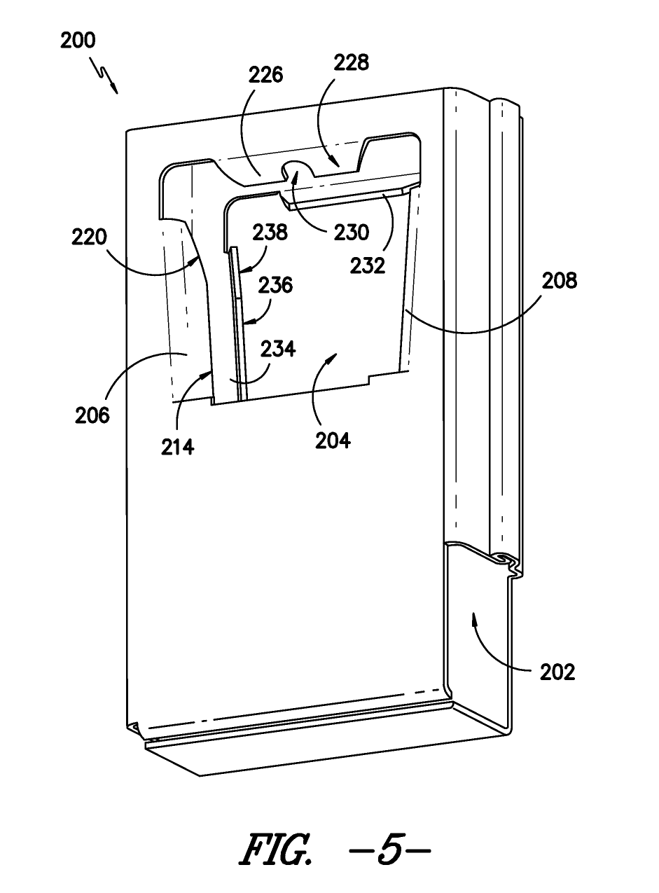

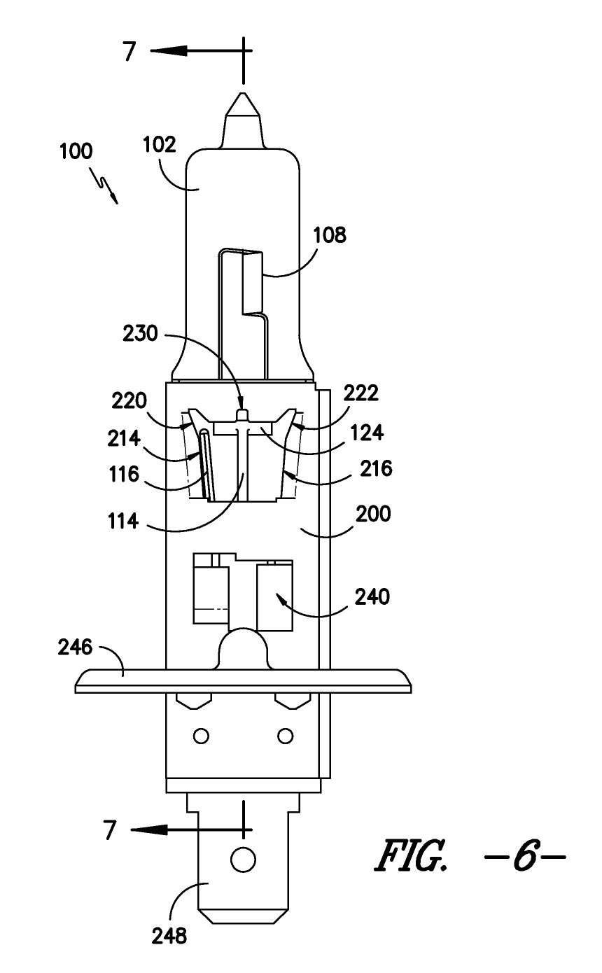

FIGS. 3 and 4 illustrate an exemplary embodiment of a sleeve 200 of the present invention. Sleeve 200 extends along longitudinal direction L and defines a channel 202 into which burner 102 is to be received. Along wide side 250, sleeve 200 includes an orienting aperture 204. On wide side 252, sleeve 200 includes an orienting aperture 212. In FIGS. 3 and 4, sleeve 200 is shown with an additional aperture 240 that includes arms 242 and 244 as may be used with an H1 style bulb. A perspective view of sleeve 200 is also shown in FIG. 5 but without aperture 240. For example, sleeve 200 as shown in FIG. 5 may be used with an H3 style bulb. Sleeve 200 may also be provided with other grooves, holes, and features (not shown) as may be used with an H3 or other bulb types. Otherwise, sleeve 200 as shown in FIGS. 3, 4, and 5 includes the same features.

Referring now to FIGS. 3, 4, and 5 and using orienting aperture 204 by way of example, orienting aperture 204 is defined in part by a pair of plates 206 and 208 positioned in an opposing manner about the longitudinal axis L. As best shown in FIG. 4, plates 206 and 208 extend inwardly into channel 202. Plates 206 and 208 include a pair of first edges 214 and 216 positioned in an opposing manner about longitudinal axis L. Each of the first edges 214 and 216 is positioned at an angle α from longitudinal axis L. By way of example, angle α may be in the range of about 2.5 degrees to about 10 degrees.

Plates 206 and 208 also include a pair of second edges 220 and 222 positioned in an opposing manner about longitudinal axis L. Each of the second edges 220 and 222 is at an angle β to the longitudinal axis L. As shown, angle β is at a larger angle from longitudinal axis L than angle α. By way of example, angle β may be in the range of about 10 degrees to about 45 degrees.

Orienting aperture 204 is further defined by a pair of tabs 226 and 228. As shown in FIG. 3, tabs 226 and 228 are positioned in an opposing manner about the longitudinal axis L and extend into channel 202 as shown in FIGS. 4 and 5. Tabs 226 and 228 define a groove 230 that extends parallel to longitudinal axis L.

Orienting aperture 204 is located on side 250 of sleeve 200. A similar construction is provided for orienting aperture 212 located on side 252 of sleeve 200 which is defined in part by plate 234 with first edge 236, second edge 238, and tab 232. As shown in FIG. 5, tab 232 does not include a groove. However, in other exemplary embodiments of the invention, tab 232 may be divided into a pair of tabs with a groove therebetween in a manner similar to tabs 226 and 228 with groove 230.

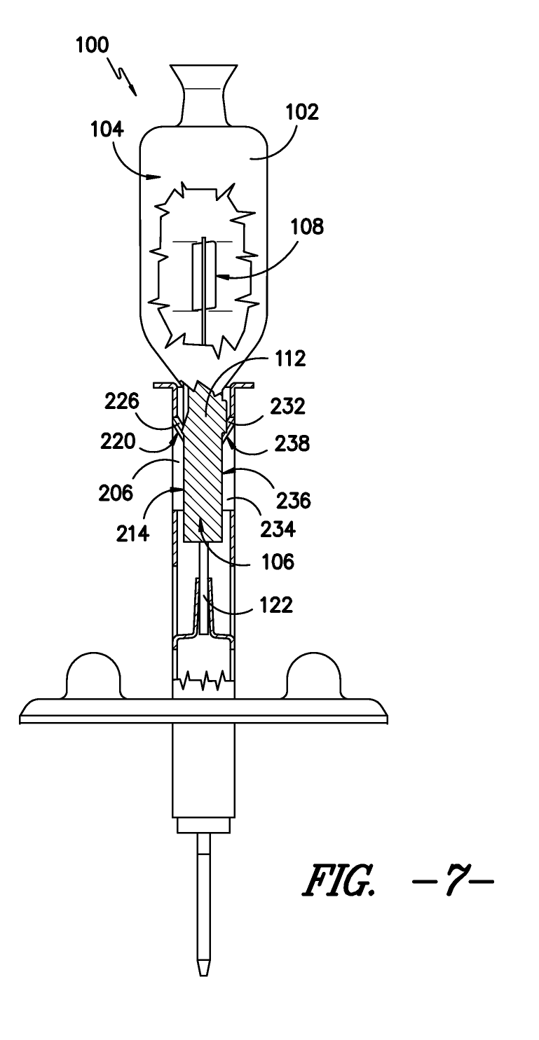

FIGS. 6 and 7 illustrate a bulb 100 with burner 102 received into position within the channel 202 of sleeve 200. FIG. 6 also illustrates a base or flange 246 connected with sleeve 200. For example, flange 246 can be pressed onto sleeve 200 and welded thereto. Base 248 includes a prong 248 as may be used for connecting with a power source. Flange 246 of sleeve 200 assists with e.g., connection into a headlamp assembly of a vehicle.

By way of example, as burner 102 is inserted into channel 202 of sleeve 200, rib 114 is received into groove 230 and guides burner 102 along longitudinal direction L. Contact between strip 116 and second edge 220 and/or contact between strip 118 and a second edge (not shown) of orienting aperture 212 can also guide the insertion of burner 102. Continued movement of burner 102 into channel 202 results in contact by stops 124 and 125 with tabs 226, 228, and 232. As these tabs can flex slightly with a sufficient force along longitudinal direction L, stops 124 and 125 will by-pass tabs 226 and 228 as well as tab 232.

Accordingly, as strip 118 contacts first edge 214 and strip 116 contacts a first edge (not shown) of orienting aperture 212, the movement of burner 102 along the longitudinal direction L is stopped. Burner 102 is also secured or fixed in position by e.g., the interaction of rib 114 and strips 116 and 118 with sleeve 200. For example, ribs 114 and strips 116, 118 properly orient burner 102 within sleeve 200 while also preventing improper lateral displacement (orthogonal to longitudinal direction L) during installation or use. At the same time, stops 124 and 125 along with tabs 226, 228, and 232 prevent unwanted movement of burner 102 along longitudinal direction L out of sleeve 200.

Accordingly, burner 102 and sleeve 200 are provided with features, complementary to each other, that secure proper alignment. More specifically, these features both properly orient burner 102 during installation into sleeve 200 as well as maintain such orientation during install and use. These features may be used with an H1 or H3 style headlamp as well as other headlamp types.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A bulb for a vehicle headlamp, comprising:
a burner defining a longitudinal axis, said burner including a base portion connected to a chamber portion, the base portion comprising
a pair of opposing wide sides;
a pair of opposing narrow sides;
at least one rib positioned on one of the wide sides of the base portion and extending along the longitudinal direction.
at least one elongated, raised strip positioned on one of the wide sides of the base portion and extending at an angle θ to the longitudinal direction, wherein said angle θ is greater than zero; and
a light emitting element extending into said chamber portion from said base portion.

2. A bulb for a vehicle headlamp as in claim 1, where said at least one rib comprises a pair of ribs, one each positioned on the opposing wide sides of the base portion.

3. A bulb for a vehicle headlamp as in claim 2, wherein said at least one strip comprises a plurality of strips positioned on one or both of the opposing wide sides.

4. A bulb for a vehicle headlamp as in claim 2, wherein said at least one strip comprises a plurality of strips positioned on each of the opposing wide sides.

5. A bulb for a vehicle headlamp as in claim 2, wherein said at least one strip comprises a pairs of strips positioned on one of the opposing wide sides.

6. A bulb for a vehicle headlamp as in claim 1, wherein said at least one strip comprises a plurality of strips positioned on one or both of the opposing wide sides.

7. A bulb for a vehicle headlamp as in claim 1, wherein said at least one strip comprises a plurality of strips positioned on each of the opposing wide sides.

8. A bulb for a vehicle headlamp as in claim 1, wherein said at least one strip comprises a pair of strips positioned on one of the opposing wide sides.

9. A bulb for a vehicle headlamp as in claim 1, wherein the angle θ is in the range of about 2.5 degrees to about 10 degrees.

10. A bulb for a vehicle headlamp as in claim 1, wherein said at least one rib is positioned at the center of one of the wide sides of the base portion.

11. A bulb for a vehicle headlamp as in claim 1, further comprising:
a sleeve defining a channel into which the base portion of said burner is received, said sleeve including at least one orienting aperture defined in part by a pair of plates positioned in an opposing manner about the longitudinal axis and extending into the channel of said sleeve, the pair of plates including
a pair of first edges positioned in an opposing manner about the longitudinal axis, each of the first edges positioned at an angle α from the longitudinal axis, wherein at least one of the first edges is also positioned adjacent to the at least one elongated, raised strip positioned on one of the wide sides of the base portion; and,
a pair of second edges positioned in an opposing manner about the longitudinal axis, each of the second edges positioned at an angle β from the longitudinal axis.

12. A bulb for a vehicle headlamp as in claim 11, wherein the at least one orienting aperture of said sleeve is further defined by a pair of tabs positioned in an opposing manner about the longitudinal axis and extending into the channel of said sleeve, the tabs defining a groove positioned about the longitudinal axis and configured for receipt of the at least one rib of the base portion of said burner.

13. A bulb for a vehicle headlamp as in claim 12, wherein said sleeve includes a pair of the orienting apertures positioned on opposing sides of said sleeve.

14. A bulb for a vehicle headlamp as in claim 11, wherein the angle α is in the range of about 2.5 degrees to about 10 degrees.

15. A bulb for a vehicle headlamp as in claim 11, wherein the at least one orienting aperture of said sleeve is further defined by a pair of tabs positioned in an opposing manner about the longitudinal axis and extending into the channel of said sleeve, the tabs defining a groove positioned along the longitudinal axis and configured for receipt of the at least one rib of the base portion of said burner, and
wherein said burner further comprises a raised stop located proximate to said at least one rib and extending perpendicular to the longitudinal axis, the stop positioned in contact with the pair of tabs.

16. A bulb for a vehicle headlamp, comprising:
a burner having a base portion connected to a chamber portion, the base portion comprising a pair of opposing wide sides and a pair of opposing narrow sides, said burner comprising
at least one rib centrally positioned on one of the wide sides of the base portion and extending along a longitudinal direction of said burner, said
at least one strip positioned on one of the wide sides of the base portion and extending at an angle θ to the longitudinal direction; and
a light emitting element positioned in said chamber portion.

17. A bulb for a vehicle headlamp as in claim 16, wherein the angle θ is in the range of about 2.5 degrees to about 10 degrees.

18. A bulb for a vehicle as in claim 16, further comprising:
a sleeve defining a channel into which the base portion of said burner is received, said sleeve including at least one orienting aperture defined by a pair of plates positioned in an opposing manner about the longitudinal axis and extending into the channel of said sleeve, the pair of plates including a first edge positioned at an angle α from the longitudinal axis and positioned in contact with the at least one elongated, raised strip positioned on one of the wide sides of the base portion.

19. A bulb for a vehicle as in claim 18, wherein the at least one orienting aperture of said sleeve is further defined by a pair of tabs positioned in an opposing manner about the longitudinal axis and extending into the channel of said sleeve, the tabs defining a groove positioned about the longitudinal axis and configured for receipt of the at least one rib of the base portion of said burner.

20. A sleeve for receipt of a burner for a vehicle headlamp, the burner defining a longitudinal axis and having a base portion and a chamber portion, the sleeve comprising:
a channel into which the base portion of the burner may be received;
at least one orienting aperture defined in part by a pair of tabs positioned in an opposing manner about the longitudinal axis and extending into said channel, the tabs defining a groove and configured for receipt of the base portion of the burner.
a pair of plates positioned in an opposing manner about the longitudinal axis and extending into the channel of the sleeve, the pair of plates defining at least part of the at least one orienting aperture, the pair of plates comprising
a pair of first edges positioned in an opposing manner about the longitudinal axis, each of the first edges positioned at an acute angle α from the longitudinal axis and configured for positioning adjacent to a strip positioned on the base portion of the burner; and
a pair of second edges positioned in an opposing manner about the longitudinal axis, each of the second edges positioned at an acute angle β from the longitudinal axis.
